(19) United States
(12) Patent Application Publication
(10) Pub. No.: US 2026/0072675 A1
(43) Pub. Date: Mar. 12, 2026

(54) METHOD AND A SOFTWARE MAINTENANCE TASK MANAGEMENT SYSTEM FOR MANAGING SOFTWARE MAINTENANCE TASKS OF A PEOPLE CONVEYOR SYSTEM

(71) Applicant: KONE Corporation, Helsinki (FI)

(72) Inventors: Mika Belov, Helsinki (FI); Mikko Piironen, Helsinki (FI)

(73) Assignee: KONE Corporation, Helsinki (FI)

(21) Appl. No.: 19/387,181

(22) Filed: Nov. 12, 2025

Related U.S. Application Data
(63) Continuation of application No. PCT/FI2023/050333, filed on Jun. 7, 2023.

(51) Int. Cl. G06F 8/65; G06F 9/48

(52) U.S. Cl. CPC G06F 8/65; G06F 9/4881

(57) ABSTRACT

A method manages software maintenance tasks of a people conveyor system and includes: obtaining a predefined sequence of software maintenance tasks of the people conveyor system; activating digital lockings related to the predefined sequence of software maintenance tasks, the digital lockings preventing execution of software maintenance tasks relating to the people conveyor system initiated by unauthenticated user; receiving a software maintenance task execution command from a user device, the software maintenance task execution command being generated by the user device in response to an interaction with an authenticated user through the user device; and initiating execution of the predefined sequence of software maintenance tasks in response receiving the software maintenance task execution command. A software maintenance task management system manages software maintenance tasks of a people conveyor system.

### TECHNICAL FIELD

The invention concerns in general the technical field of people conveyor systems. Especially the invention concerns managing software maintenance tasks of people conveyor systems.

### BACKGROUND

People conveyor systems, such as elevator systems, require typically several maintenance tasks including software maintenance tasks. The conveyor systems comprise different components provided with a processor running a component specific application software. During the lifetime of the people conveyor system, new features and/or corrections of existing features may be provided in the form of new software versions. To be able to take advantage of the new features and/or the corrected existing features, the application software of one or more components of the people conveyor system require updating.

The software maintenance tasks, such as software updating, may be performed manually on-site, e.g. by a service technician. Typically, in the manual update process the service technician enters the people conveyor site, removes the people conveyor system from normal operation, connects a computing device, such as a laptop, to a people conveyor control system, and updates the software. After the execution of the update process, the service technician restores the normal operation of the people conveyor system and checks correct operation. The software maintenance tasks may also be performed remotely, which enables carrying out the software maintenance tasks automatically. The remote update process may require interruption of the normal operation of the people conveyor system during the update process. However, there exists a need to develop solutions for managing software maintenance tasks of people conveyor systems.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method and a software maintenance task management system for managing software maintenance tasks of a people conveyor system. Another objective of the invention is that the method and a software maintenance task management system for managing software maintenance tasks of a people conveyor system improve management of software maintenance tasks of the people conveyor system.

The objectives of the invention are reached by a method and a software maintenance task management system as defined by the respective independent claims.

According to a first aspect, a method for managing software maintenance tasks of a people conveyor system is provided, wherein the method comprises: obtaining a predefined sequence of software maintenance tasks of the people conveyor system; activating digital lockings related to the predefined sequence of software maintenance tasks, wherein the digital lockings prevent execution of software maintenance tasks relating to the people conveyor system initiated by unauthenticated user; receiving a software maintenance task execution command from a user device, wherein the software maintenance task execution command is generated by the user device in response to an interaction with an authenticated user through the user device; and initiating execution of the predefined sequence of software maintenance tasks in response receiving the software maintenance task execution command.

The method may further comprise storing, after execution of each software maintenance task of the predefined sequence of software maintenance tasks, execution status and logging data related to the execution of said software maintenance task.

The software maintenance tasks may be arranged into the predefined sequence based on priorities assigned to the software maintenance tasks.

One or more software maintenance tasks of the predefined sequence of software maintenance task may comprise at least one sub-task.

Alternatively or in addition, the method may further comprise: receiving an interruption command before executing all software maintenance tasks of the predefined sequence of software maintenance task, wherein the non-executed software maintenance tasks of the predefined sequence of software maintenance tasks are set as pending software maintenance tasks; interrupting the execution of the pending software maintenance tasks; and preventing execution of new software maintenance tasks of the people conveyor system before the pending software maintenance tasks are executed.

The method may further comprise: receiving an execution continuation command to continue executing the pending software maintenance tasks from a user device, wherein the execution continuation command is generated by the user device in response to an interaction with an authenticated user through the user device; and continuing the execution of the pending software maintenance tasks in response receiving the execution continuation command.

The plurality of software maintenance tasks of the people conveyor system may comprise: one or more software update tasks, one or more software sub-assembly addition tasks, one or more parameter modifying tasks, one or more setting modifying tasks, one or more feature implementation tasks, one or more service implementation tasks, and/or one or more service integration tasks.

According to a second aspect, a software maintenance task management system of a people conveyor system is provided, wherein the software maintenance task management system comprises: a user device, and a control system configured to: obtain a predefined sequence of software maintenance tasks of the people conveyor system; activate digital lockings related to the predefined sequence of software maintenance tasks, wherein the digital lockings prevent execution of software maintenance tasks relating to the people conveyor system initiated by unauthenticated user; receive a software maintenance task execution command from the user device, wherein the software maintenance task execution command is generated by the user device in response to an interaction with an authenticated user through the user device; and initiate execution of the predefined sequence of software maintenance tasks in response receiving the software maintenance task execution command.

The control system may further be configured to store, after execution of each software maintenance task of the predefined sequence of software maintenance tasks, execution status and logging data related to the execution of said software maintenance task.

The software maintenance tasks may be arranged into the predefined sequence based on priorities assigned to the software maintenance tasks.

One or more software maintenance tasks of the predefined sequence of software maintenance task may comprise at least one sub-task.

Alternatively or in addition, the control system may further be configured to: receive an interruption command before executing all software maintenance tasks of the predefined sequence of software maintenance task, wherein the non-executed software maintenance tasks of the predefined sequence of software maintenance tasks are set as pending software maintenance tasks; interrupt the execution of the pending software maintenance tasks; and prevent execution of new software maintenance tasks of the people conveyor system before the pending software maintenance tasks are executed.

The control system may further be configured to: receive an execution continuation command to continue executing the pending software maintenance tasks from a user device, wherein the execution continuation command is generated by the user device in response to an interaction with an authenticated user through the user device; and continue the execution of the pending software maintenance tasks in response receiving the execution continuation command.

The plurality of software maintenance tasks of the people conveyor system may comprise: one or more software update tasks, one or more software sub-assembly addition tasks, one or more parameter modifying tasks, one or more setting modifying tasks, one or more feature implementation tasks, one or more service implementation tasks, and/or one or more service integration tasks.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a people conveyor system, wherein the people conveyor system is an elevator system.

FIG. 2 illustrates schematically another example of the people conveyor system, wherein the people conveyor system is an escalator system.

FIG. 3 illustrates schematically an example of a software maintenance task management system for managing software maintenance tasks of the people conveyor system.

FIG. 4 illustrates schematically an example of a method for managing software maintenance tasks of the people conveyor system.

FIG. 5 illustrates schematically another example of the method for managing software maintenance tasks of the people conveyor system.

FIG. 6 illustrates schematically an example situation, wherein the software maintenance task management system further comprises at least one other user device.

FIG. 7 illustrates schematically an example method for verifying an integration of the people conveyor system with an on-site system.

FIG. 8 illustrates schematically an example of components of a control system of the software maintenance task management system.

### DESCRIPTION OF THE EXEMPLIFYING EMBODIMENTS

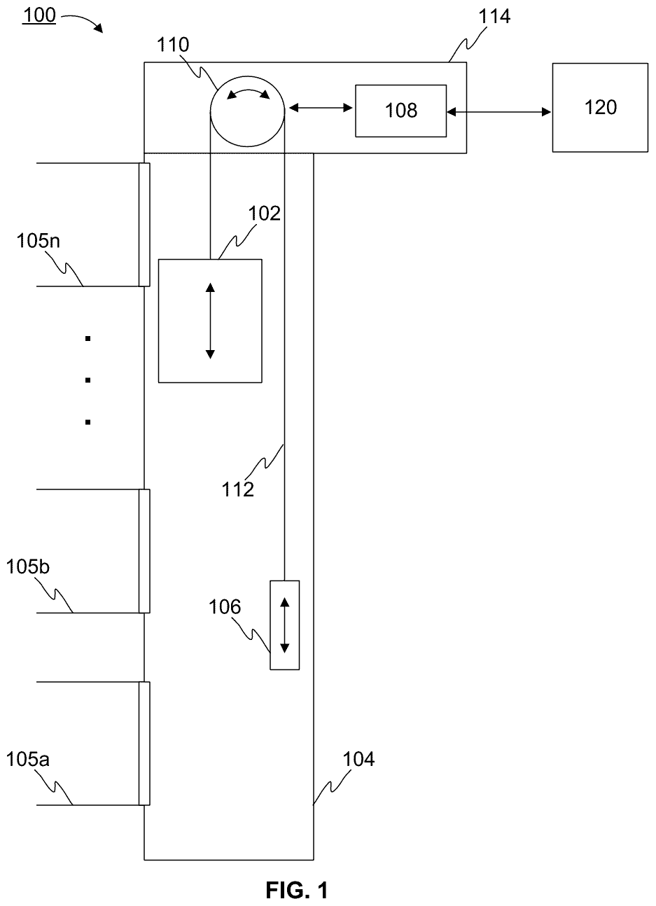

FIG. 1 illustrates schematically an example of a people conveyor system 100, 200, wherein the people conveyor system 100, 200 is an elevator system 100. The elevator system 100 comprises at least one elevator car 102 configured to travel along a respective elevator shaft 104 between a plurality of floors (i.e. landings) 105a-105n, a counterweight 106, and an elevator control system 108. The elevator system 100 may also form an elevator group, i.e. group of two or more elevator cars 102 each travelling along a separate elevator shaft 104 configured to operate as a unit serving the same landings 105a-105n. The elevator system 100 further comprises a hoisting machinery system configured to drive the at least one elevator car 102 along the respective elevator shaft 104 between the floors. The elevator hoisting machinery may comprise for example a motor and a traction sheave 110 for lifting the elevator car 102. For illustrative purposes, only the traction sheave 110 is shown in FIG. 1. The elevator car 102, the hoisting machinery and the counterweight 106 are interconnected via hoisting roping arrangement 112 routed via the traction sheave 110 and a plurality of pulleys, which are not shown in FIG. 1 for sake of clarity. When the traction sheave 110 rotates, the elevator car 102 and the counterweight 106 are moving. The hoisting roping arrangement 112 comprises at least one hoisting rope. In the elevator implementation of the people conveyor system 100, 200, the elevator control system 108 is the conveyor control system. The elevator control system 108 is configured to at least control the operations of the elevator system 100. The elevator control system 108 may locate inside a machine room 114 (as illustrated in the example of FIG. 1) or at one of the floors, e.g. in a machine roomless elevator system. The elevator control system 108 is communicatively coupled to the other entities of the elevator system 100. The communication between the elevator control system 108 and the other entities of the elevator system 100 may be based on one or more known communication technologies, either wired or wireless. The implementation of the elevator control system 108 may be done as a stand-alone control entity or as a distributed control environment between a plurality of stand-alone control entities, such as a plurality of servers, providing distributed control resource. The elevator system 100 may further comprise one or more known elevator related entities, e.g. user interface devices, elevator doors, safety circuit and devices, and/or elevator brakes, etc., which are not shown in FIG. 1 for sake of clarity.

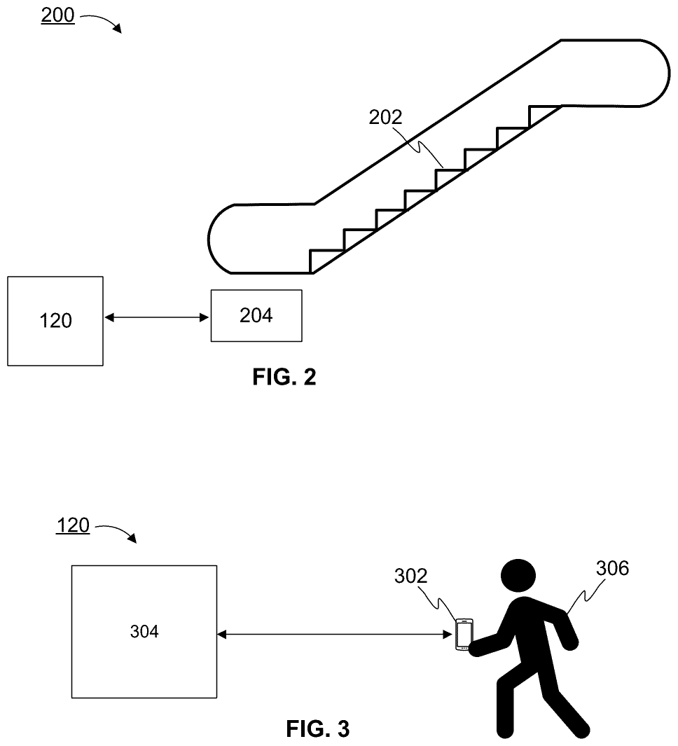

FIG. 2 illustrates schematically another example of the people conveyor system 100, 200, wherein the people conveyor system 100, 200 is an escalator system 200. The escalator system 200 comprises a chain of steps 202 arranged to an endless conveyor band, which is carried by a truss, and an escalator control system 204. For illustrative purposes, only the chain of steps and the escalator control system 204 are shown in FIG. 2. However, the escalator system 200 may further comprise one or more other known escalator related entities, e.g. a driving machine including at least one motor, etc., which are not shown in FIG. 2. The chain of steps 202 is coupled to the at least one motor via transmission comprising at least a chain or belt or similar. The motor may generate a rotational force via the transmission causing the chain of steps 202 to move in an intended travelling direction. In the escalator implementation of the people conveyor system 100, 200, the escalator control system 204 is the conveyor control system. The escalator control system 204 may be configured to control the operation of the escalator system 200 at least in part, e.g. to control the movement of the chain of steps 202. The escalator control system 204 may for example be arranged to one of the platforms of the escalator system 200. In the example of FIG. 2 the escalator control system 204 is arranged to a bottom platform, of the escalator system 200. Alternatively, the escalator control system 204 may be arranged for example to a top platform, of the escalator system 200. The escalator control system 204 is communicatively coupled to the other entities of the escalator system 200. The communication between the escalator control system 204 and the other entities of the escalator system 200 may be based on one or more known communication technologies, either wired or wireless. The implementation of the escalator control system 204 may be done as a stand-alone control entity or as a distributed control environment between a plurality of stand-alone control entities, such as a plurality of servers, providing distributed control resource. The expression “escalator system” used in this patent application covers also moving walk systems. The moving walk system is otherwise similar to the escalator system 200 described above referring to FIG. 2, but instead of the chain of steps 202 the moving walk system comprises a chain of pallets arranged to the endless conveyor band. Thus, everything disclosed above referring to the escalator system 200 above applies also to the moving walk system. The moving walk system may be an inclined moving walk system, i.e. a moving walk system configured to convey people and/or goods across an inclined plane, e.g. between two platforms. Alternatively, the mowing walk system may be a horizontal moving walk system, i.e. a moving walk system configured to convey people and/or goods across a horizontal plane, e.g. between two platforms.

The conveyor control system 108, 204 is communicatively coupled to a software maintenance task management system 120 of the people conveyor system 100, 200. The software maintenance task management system 120 is configured to manage software maintenance tasks of the people conveyor system 100, 200. The software maintenance task management system 120 comprises a user device 302 and a control system 304. The conveyor control system 108, 204 may for example be communicatively coupled to the control system 304 of the software task management system 120. The communication between the conveyor control system 108, 204 and the control system 304 of the software task management system 120 may be based on one or more known communication technologies, either wired or wireless. For example, the elevator control system 108 is communicatively coupled to the software maintenance task management system 120 (e.g. to the control system 304) in the example of FIG. 1. According to another example, the escalator control system 204 is communicatively coupled to the software maintenance task management system 120 (e.g. to the control system 304) in the example of FIG. 2. FIG. 3 illustrates schematically an example of the software maintenance task management system 120 for managing software maintenance tasks of the people conveyor system 100, 200. The control system 304 may be a local control system and/or a remote-control system. The local control system, i.e. an on-site control system, is located at the people conveyor system 100, 200. The remote-control system, i.e. an off-site control system, is located remote from the people conveyor system 100, 200. The implementation of the control system 304 may be done as a stand-alone control entity or as a distributed control environment between a plurality of stand-alone control entities, such as a plurality of servers, providing distributed control resource. The control system 304 may for example be a cloud server, the people conveyor control system 108, 204, building management control system, a local server, a service center, a maintenance center, or a data center. The user device 302 is communicatively coupled to the control system 304. The communication between the user device 302 and the control system 304 may be based on one or more known communication technologies, either wired or wireless. The user device 302 may for example be a people conveyor system user interface device or a mobile terminal device. In the example of FIG. 3 the user device 302 is a mobile terminal device, but it is only a non-limiting example and the user device 302 may also be a people conveyor system user interface device. The mobile terminal device may for example be a mobile phone or a tablet computer. In the elevator system implementation, the people conveyor system user interface device may for example be an elevator call device or a maintenance panel. The elevator call device may for example be a destination call device, such as a destination operation panel (DOP), for providing destination calls to desired destination floors from the floor which the destination call device locates; a car call device, such as a car operation panel (COP), for providing elevator car calls to drive the elevator car 102 to desired destination floors; or a landing call device, such as a landing call station (LCS), for providing landing calls to drive the elevator car 102 to the floor, where the landing call device locates. In the escalator system implementation, the people conveyor system user interface device may for example be a maintenance panel. The software maintenance task management system 120 may further comprise at least one other user device 602a-602d as will be described later in this application. Everything disclosed above referring to the user device 302 above applies also to the at least one other user device 602a-602d.

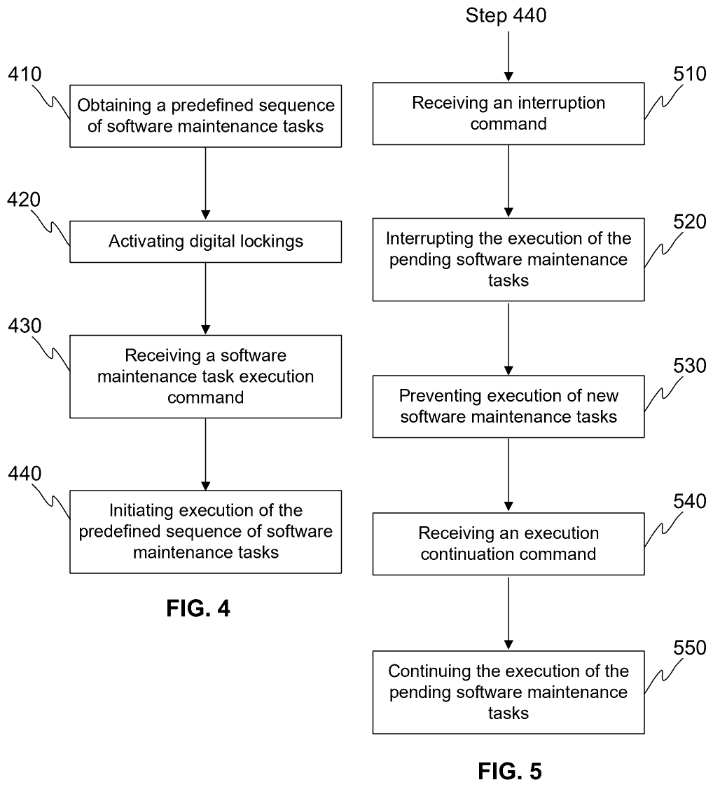

Next an example of a method for managing software maintenance tasks of the people conveyor system 100, 200 by the software maintenance task management system 120 is described by referring to FIG. 4. FIG. 4 schematically illustrates the example of the method as a flow chart.

At a step 410, the control system 304 obtains a predefined sequence of software maintenance tasks of the people conveyor system 100, 200. The predefined sequence of software maintenance tasks of the people conveyor system 100, 200 may for example be defined by a maintenance task planner unit. The maintenance task planner unit may be a part of the control system 304. Alternatively, the maintenance task planner unit may be a separate entity configured to provide the predefined sequence of software maintenance tasks to the control system 304. The predefined sequence of software maintenance tasks is assigned to a specific user 306, e.g. a maintenance technician, who is authenticated to initiate execution of said predefined sequence of software maintenance tasks. In other words, only the unauthenticated user 306, e.g. an authenticated maintenance technician, to which the predefined sequence of software maintenance task is assigned, is allowed to initiate said predefined sequence of software maintenance tasks of the people conveyor system 100, 200. The authenticated user 306 needs to be identified before the authenticated user 306 may initiate the execution of the predefined sequence of software maintenance tasks of people conveyor system 100, 200 as will be described later in this application. With the term “software maintenance task” is meant throughout this application an editing task related to the software of the people conveyor system 100, 200. However, internal software tasks of the software of people conveyor are not considered as software maintenance tasks of the people conveyor system 100, 200 in this application. The predefined sequence of software maintenance tasks of the people conveyor system 100, 200 may for example comprise: one or more software update tasks, one or more software sub-assembly addition tasks, one or more parameter modifying tasks, one or more setting modifying tasks, one or more feature implementation tasks, one or more service implementation tasks, and/or one or more service integration tasks. The software maintenance tasks may be arranged into the predefined sequence for example based on priorities assigned to the software maintenance tasks. Alternatively or in addition, the software maintenance tasks may be arranged into the predefined sequence for example based on some other execution order. According to an example, one or more software maintenance tasks of the predefined sequence of software maintenance task may comprise at least one sub-task.

At a step 420, the control system 304 activates digital lockings related to the predefined sequence of software maintenance tasks. The digital lockings prevent execution of software maintenance tasks relating to the people conveyor system 100, 200 initiated by unauthenticated users (i.e. any other user than the authenticated user 306), until the digital lockings are inactivated. Thus, the digital lockings prevent any changes to the software of the people conveyor system 100, 200. Although, the digital lockings prevent the execution of the software maintenance tasks initiated by the unauthenticated users, the execution of the predefined sequence of software maintenance tasks initiated by the authenticated user 306, to which the predefined sequence of software maintenance task is assigned, is permitted. Each software maintenance task of the predefined sequence of software maintenance tasks may have a separate digital locking. Alternatively, some software maintenance tasks of the predefined sequence of software maintenance tasks may have common digital lockings and the rest of the software maintenance tasks of the predefined sequence of software maintenance tasks may each have a separate digital locking. According to an example, the people conveyor control system 108, 204 may be digitally locked to prevent execution of software maintenance tasks relating to the people conveyor control system 108, 204 by unauthenticated users, until the digital locking of the people conveyor control system 108, 204 is inactivated. According to another example, one or more functionalities of the people conveyor system 100, 200 may be digitally locked to prevent execution of software maintenance tasks relating to said one or more functionalities of the people conveyor system 100, 200 by unauthenticated users, until the digital lockings of the one or more functionalities of the people conveyor system are inactivated. If a software maintenance task (called as “a main task”) comprises one or more sub-tasks, a separate digital locking may be established for each sub-task of the main task. Alternatively, a common digital locking may be established for all sub-tasks of the main task. Separate digital lockings may be established for the main task and its one or more sub-tasks, wherein each sub-task may have a separate digital locking, all sub-tasks may have a common digital locking, or some sub-tasks may each have separate digital lockings and some sub-tasks may have a common digital locking. Alternatively, a common digital locking may be established for the main task and its one or more sub-tasks.

At a step 430, the control system 304 receives a software maintenance task execution command from the user device 302. The software maintenance task execution command is generated by the user device 302 in response to an interaction with the authenticated user 306, to which the predefined sequence of software maintenance tasks is assigned, through the user device 302. For example, the user device 302 may generate the software maintenance task execution command in response to receiving user input, e.g. via a user interface of the user device 302, by the authenticated user 306. The user device 302 may for example comprise a display, e.g. a touchscreen, displaying a list of the predefined sequence of software maintenance tasks. The authenticated user 306 may select from the list the software maintenance tasks to be executed. In response to the selection of the maintenance tasks to be executed by the authenticated user 306, the user device 302 may generate the software maintenance task execution command. The authenticated user 306 may select at once all the software maintenance tasks of the predefined sequence of software maintenance tasks to be executed. In that case the generated software maintenance task execution command comprises a command to execute all the software maintenance tasks of the predefined sequence of software maintenance tasks. Alternatively, the authenticated user 306 may select one or more of the software maintenance tasks of the predefined sequence of software maintenance tasks to be executed at a time. In that case the generated software maintenance task execution command comprises a command to execute the selected software maintenance tasks of the predefined sequence of software maintenance tasks and after the execution of the selected the selected software maintenance tasks, the authenticated user 306 may again select one or more of the software maintenance tasks of the predefined sequence of software maintenance tasks to be executed, until all of the predefined sequence of software maintenance tasks have been executed. Before being able to enter the user input, the identification of the authenticated user 306 is required. The identification may for example be based using keycards, tags, and/or identification codes, such as personal identity number (PIN) code or ID number, etc. The identification of the authenticated user 306 may be performed e.g. via the user device 302.

At a step 440, the control system 304 initiates execution of the predefined sequence of software maintenance tasks in response to receiving the software maintenance task execution command from the user device 302. The people conveyor system 100, 200 may need to be taken out of service, i.e. the operation of the people conveyor system 100, 200 may need to be interrupted, during the execution of at least part of the predefined sequence of software maintenance tasks. The need to take the people conveyor system 100, 200 out of service during the execution of at least part of the predefined sequence of software maintenance tasks may for example depend on criticality level of the software maintenance tasks to be executed. For example, if a software maintenance task belonging to the predefined sequence of software maintenance tasks concerns a safety related portion of the software, then the people conveyor system 100, 200 needs to be taken out of service during at least the execution said software maintenance task. If, however, a software maintenance task belonging to the predefined sequence of software maintenance tasks is independent, e.g. a container software approach, from the software, then it is not necessary to take the people conveyor system 100, 200 out of service during the execution of said software maintenance task. It may also be that the safety related portion of the software cannot, e.g. by regulations, be modified, and the software maintenance tasks, e.g. added features, concerning the safety related portion of the software need to be done as additional software portions which do not affect the operation of the safety related portion of the software.

According to an example, the control system 304 may further store, after the execution of each software maintenance task of the predefined sequence of software maintenance tasks, execution status and logging data related to the execution of said software maintenance task. The execution status data and logging data may for example comprise data representing a status of the people conveyor system 100, 200 before the execution of said software maintenance task (e.g. version of the software maintenance task before the execution, process status, who started the execution, what software maintenance task will be executed, start time of the execution of the software maintenance task, and/or end time of the execution of the software maintenance task, etc.) and/or a status of the people conveyor system 100, 200 after the execution of said software maintenance task (e.g. version of the software maintenance task after the execution, and/or process status, etc.). The execution status and the logging data may for example be stored into a memory unit 820 of the control system 304 and/or into an external memory unit, e.g. a database. The storing of the execution status and logging data enables an inspection of the executed software maintenance tasks afterwards. For example, the stored execution status and logging data may be used for simulation and/or playback purposes in a digital twin implementation as will be described later in this application.

FIG. 5 illustrates schematically another example of the method for managing software maintenance tasks of the people conveyor system 100, 200. The method according to the example of FIG. 5 further comprises a software maintenance task execution interruption functionality. The software maintenance task execution interruption functionality enables that the execution of the predefined sequence of software maintenance task may be interrupted and continued later, if the predefined sequence of software maintenance tasks cannot be completed at one go. The continuation of the execution of the predefined sequence of software maintenance tasks after the interruption may be initiated by the same authenticated user 306 from which the initial software maintenance task execution command is received at the step 430 or by another authenticated user 604 as will be described later.

At a step 510, the control system 304 may receive an interruption command before executing all the software maintenance tasks of the predefined sequence of software maintenance task. The non-executed software maintenance tasks of the predefined sequence of software maintenance tasks are set as pending software maintenance tasks. The interruption command may for example be received from the user device 302. The interruption command may be generated by the user device 302 in response to an interaction with the authenticated user 306 through the user device 302. For example, the user device 302 may generate the software maintenance task execution command in response to receiving user input, e.g. via the user interface of the user device 302, by the authenticated user 306. Alternatively, the interruption command may for example be generated by the control system 304 itself upon encountering an unsolvable problem. In this case the execution of the software maintenance tasks of the predefined sequence of the software maintenance tasks needs to be halted to a safe condition, wherein the already executed software maintenance tasks are known to function correctly together with the people conveyor system 100, 200. These safe conditions (i.e. safe steps) may be predefined e.g. by the maintenance task planner unit.

At a step 520, the control system 304 may interrupt the execution of the pending software maintenance tasks in response to receiving the interruption command. The operation of the people conveyor system 100, 200 may be continued during the interruption of the execution of the pending software maintenance tasks. For example, the people conveyor system 100, 200 may be running in a compatibility mode.

At a step 530, in response to receiving the interruption command the control system 304 further prevents execution of new software maintenance tasks of the people conveyor system 100, 200 before the pending software maintenance tasks are executed. The execution of the new software maintenance tasks of the people conveyor system 100, 200 may be prevented digitally until the pending software maintenance tasks are executed. For example, if there are pending software maintenance tasks relating to a certain entity or functionality of the people conveyor system 100, 200, which is known to interact with a certain other entity of functionality of the people conveyor system 100, 200, and the software maintenance tasks are paused to a state, which is known not to be the final state, then the new software maintenance tasks to the entities or functionalities with dependencies may be prevented digitally until the pending software maintenance tasks are finalized.

At a step 540, the control system 304 may receive an execution continuation command to continue executing the pending software maintenance tasks from a user device 302, 602a-602d. The execution continuation command is generated by the user device 302 in response to an interaction with an authenticated user 306, 604 through the user device 302, 602a-602d. For example, the user device 302, 602a-602d may generate the software maintenance task execution command in response to receiving user input, e.g. via a user interface of the user device 302, 602a-602d, by the authenticated user 306, 604. Before being able to enter the user input, the identification of the authenticated user 306, 604 is required. The identification of the authenticated user 306, 604 may be performed as described above referring to step 430. The user device 302, 602a-602d from which the execution continuation command is received at the step 540 may be the same user device 302, from which the initial software maintenance task execution command is received at the step 430 discussed above. Alternatively, the user device 302, 602a-602d from which the execution continuation command is received at the step 540 may be another user device 602a-602d than the user device 302 from which the initial software maintenance task execution command is received at the step 430 discussed above. The authenticated user 306, 604 interacting with the user device 302, 602a-602d to generate the execution continuation command may be the same authenticated user 306 interacting the user device 302 to generate the initial software maintenance task execution command at the step 430 discussed above. Alternatively, the authenticated user 306, 604 interacting with the user device 302, 602a-602d to generate the execution continuation command may be another authenticated user 604 than the authenticate user 306 interacting with the user device 302 to generate the initial software maintenance task execution command at the step 430 discussed above. In order the other authenticated user 604 to be abled to continue the execution of the pending software maintenance tasks, the pending software maintenance tasks may need to be reassigned for the other authenticated user 604. The possibility to hand over the continuation of the executing the pending software maintenance tasks from the initial unauthenticated user 306 to another unauthenticated user 604 enables that the execution of the pending software maintenance tasks may still be continued even if the initial unauthenticated user 306 is not able or available to continue the execution of the pending software maintenance tasks.

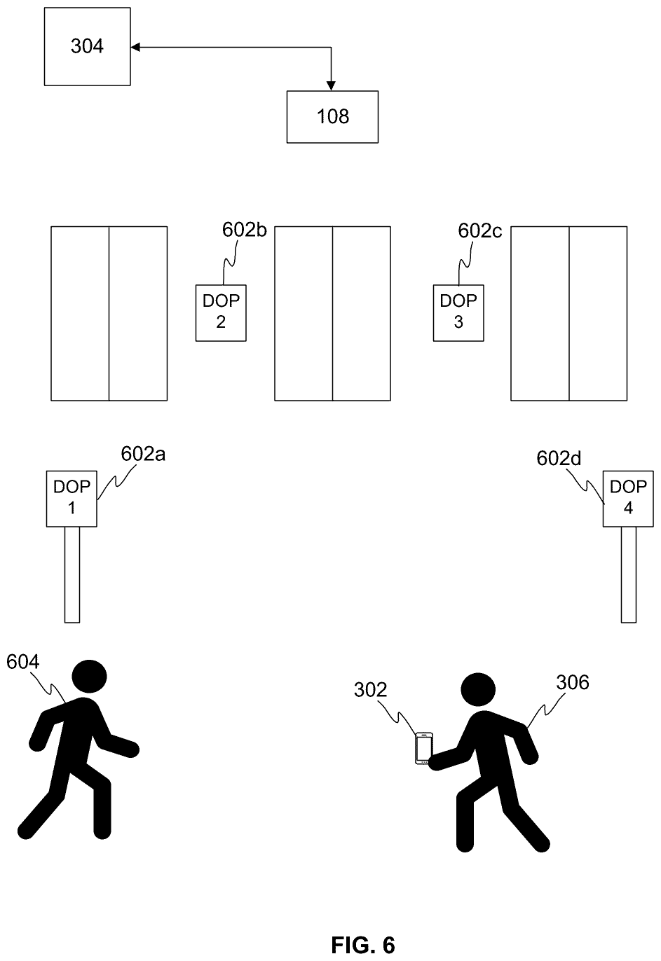

FIG. 6 illustrates an example situation, wherein the software maintenance task management system 120 further comprises at least one other user device 602a-602d in addition to the user device 302. In the example of FIG. 6, the software maintenance task management system 120 comprises the user device 302 (e.g. a first user device) and four other user devices 602a-602d. However, the software maintenance task management system 120 is not limited to that and it may also comprise any other number of other user devices 602a-602d. In the example of FIG. 6, the first user device 302 is a mobile device and the other user device 602a-602d are DOPs. However, at least one or all of the other user devices 602a-602d may also be mobile devices or other people conveyor system user interface devices. In the example situation of FIG. 6, the software maintenance task execution command (the step 430) is generated to the control system 304 by the first user device 302 in response to the interaction with the authenticated user 306 (e.g. a first authenticated user), to which the predefined sequence of software maintenance tasks are assigned, through the user device 302 as discussed above. Furthermore, in the example situation of FIG. 6, the execution of the pending software maintenance tasks is interrupted in response to receiving the interruption command as discussed above and the execution continuation command is generated by another user device 602a-602d (e.g. a second user device 602a) in response to an interaction with another authenticated user 604 (e.g. a second authenticated user) through the second user device 602a.

At a step 550, the control system 304 may continue the execution of the pending software maintenance tasks in response receiving the execution continuation command.

After the execution of each software maintenance tasks of the predefined sequence of software maintenance tasks, the authenticated user 306, 604 may observe the status of the people conveyor system 100, 200. If the status of the people conveyor system 100, 200 is not nominal, i.e. the people conveyor system 100, 200 does not behave as intended or as planned, the authenticated user 306, 604 may interact with the respective user device 302, 602a-602d to generate a rollback initiation command to the control system 304 to initiate at least partial rollback process for the executed software maintenance task to restore the previous version of said software maintenance task, in which the people conveyor system behaves as intended or planned. In response to receiving the rollback initiation command the control system 304 may initiate the at least partial rollback process. After the at least partial rollback process, the authenticated user 306, 604 may try to reinitiate the execution of said software maintenance task similarly as described above referring to steps 430-440. Alternatively, the authenticated user 306, 604 may interact with the respective user device 302, 602a-602d to generate an execution accomplished command to the control system 304. If the software maintenance task comprises at least one sub-task, the observation of the status of the people conveyor system 100, 200 may be performed after execution of the whole software maintenance task or after one or more sub-tasks of the at least sub-task of said software maintenance task, or after each sub-task of the at least one sub-task of said software maintenance task. According to an example, the execution of the next software maintenance task of the predefined sequence of software maintenance task may not be allowed, if after the previously executed software maintenance task of the predefined sequence of software maintenance task is not nominal. If the status of the people conveyor 100, 200 is nominal, the authenticated user 306, 604 may accept the execution of said software maintenance task via an interaction with the respective user device 302, 602a-602d to generate the execution accomplished command to the control system 304. In response to receiving the execution accomplished command from the user device 302, 602a-602d, the control system 304 may release, i.e. inactivate, the digital locking related to the said software maintenance task, if said maintenance task has a separate digital locking. Otherwise, the control system 304 may release the common digital locking, in response to receiving the execution accomplished command of each software maintenance task belonging to said common digital locking from the user device 302, 602a.

Above the invention is described so that the predefined sequence of software maintenance tasks is executed directly in the people conveyor system 100, 200. However, the people conveyor system 100, 200 may need to be taken out of service during the execution of the predefined sequence of software maintenance tasks as described above. According to an example, the predefined sequence of software maintenance tasks may first be executed in a digital twin of the people conveyor system 100, 200 before the actual execution of the predefined sequence of software maintenance tasks in the people conveyor system 100, 200. The digital twin of the people conveyor system 100, 200 represents a digital representation of the people conveyor system 100, 200. The digital twin enables simulations and testing of the people conveyor system 100, 200. While the predefined sequence of software maintenance tasks is executed in the digital twin of the people conveyor system 100, 200, the people conveyor system 100, 200 stays in operation and the digital lockings activated at the step 420 prevent the execution of new software maintenance tasks of the people conveyor system 100, 200 and thus any changes to the software of the people conveyor system 100, 200.

The authenticated user 306 may initiate the execution of the predefined sequence of software maintenance tasks in the digital twin similarly as described above (steps 430-440) regarding to the execution of the predefined sequence of software maintenance tasks in the people conveyor system 100, 200. After the execution of the predefined sequence of software maintenance tasks in the digital twin, the authenticated user 306 may observe the status of the digital twin. If the status of the digital twin is not nominal after the execution of the predefined sequence of software maintenance tasks, the executed software maintenance task may be cancelled without disturbing the operation of the people conveyor system 100, 200. If the status of the digital twin is nominal after the execution of the predefined sequence of software maintenance tasks, the authenticated user 306 may interact with the user device 302 to generate the software maintenance task execution command to the control system 304 as described above at the step 430. In response to receiving the software maintenance task execution command from the user device 302, the control system 304 initiates execution of the predefined sequence of software maintenance tasks in the people conveyor system 100, 200 as described above at the step 440. Before initiating the execution of the predefined sequence of software maintenance tasks in the people conveyor system 100, 200, the people conveyor system 100, 200 needs to be taken out of operation during the execution of the predefined sequence of software maintenance tasks in the people conveyor system 100, 200 as also described above. One or more of the further method steps described above may also be applied to this embodiment, wherein the predefined sequence of software maintenance tasks is first executed in the digital twin of the people conveyor system 100, 200 before the actual execution of the predefined sequence of software maintenance tasks in the people conveyor system 100, 200. The use of the digital twin for testing purposes enables verifying the correct operation of the people conveyor system 100, 200 after the execution of the predefined sequence of software maintenance tasks before the actual execution of the predefined sequence of software maintenance tasks in the people conveyor system 100, 200. This also minimizes the downtime of the people conveyor system 100, 200 due to the execution of the predefined sequence of software maintenance tasks. The digital twin may also be used to emulate the operation of the actual software of the people conveyor system 100, 200 in use by utilizing sensor data of the actual people conveyor system 100, 200, where applicable. For example, by utilizing the sensor data of the actual people conveyor system 100, 200 in the digital twin, the functionalities of the software after the execution of the predefined sequence of software maintenance tasks may be tested. The functionalities of the software in the digital twin may be tested in parallel with the functionalities of the actual software of the people conveyor system 100, 200. The differences in the functionalities of the software in the digital twin and the functionalities of the actual software during certain events may be reported, e.g. to the user interface device 302 and/or to a cloud server, for further analyzing.

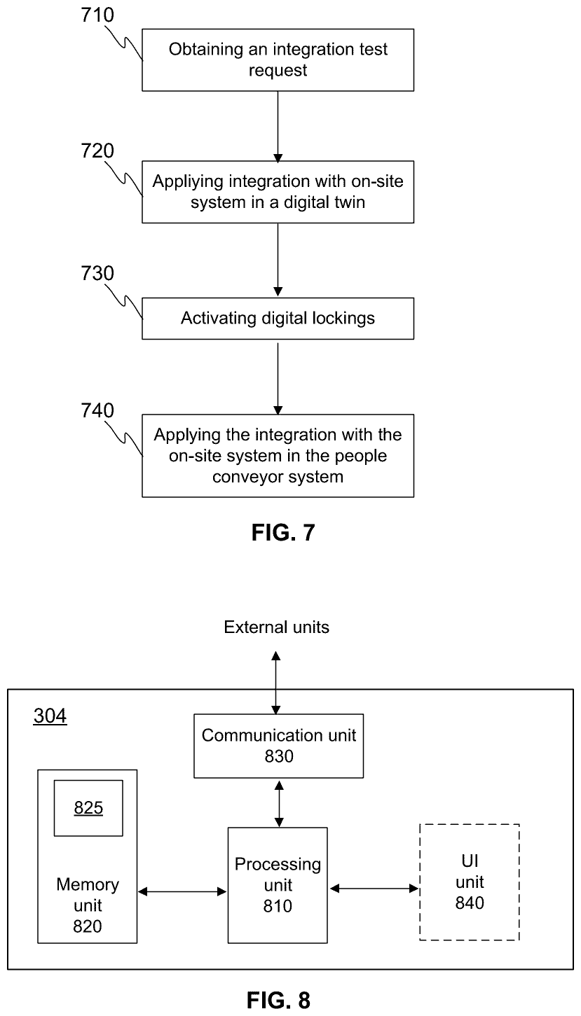

The digital twin of the people conveyor system 100, 200 may also be used for simulation and/or playback purposes. The simulation and/or playback may for example be used for training purposes of maintenance personnel. For example, the stored execution status and logging data related to the executed software maintenance tasks may be used in the simulation and/or playback. Alternatively or in addition, the digital twin of the people conveyor system 100, 200 may also be used for testing integrations, e.g. application programming interface (API) integrations, with on-site systems, e.g. third party on-site systems, before applying the integration to the actual people conveyor system 100, 200 and without affecting the operation of the people conveyor system 100, 200. Some non-limiting examples of the third party on-site system integrations comprise building management system (BMS) integration, access control system integration, fire services integration, and/or evacuation system integration. FIG. 7 illustrates an example method for verifying an integration of the people conveyor system 100, 200 with an on-site system.

At a step 710, the control system 304 obtains an integration test request. The integration test request may for example be obtained from the on-site system, e.g. a third party on-site system.

At a step 720, the control system 304 applies the integration with the on-site system in the digital twin of the people conveyor system 100, 200 to test and verify the operation of the integration. As the testing is performed in the digital twin, the testing does not affect the operation of the people conveyor system 100, 200. If applicable, old integration may stay in use in the people conveyor system 100, 200 during the testing and verifying. The use of the digital twin enables testing the integrations without a need to build a separate on-site test setup and taking the people conveyor system 100, 200 out of service. This also minimizes the downtime of the people conveyor system 100, 200.

At a step 730, after the testing and verifying in the digital twin that the integration with the on-site system is operating as expected, the control system 304 may activate digital lockings related to the on-site system integration in the people conveyor system 100, 200.

At a step 740, the control system 304 may apply the integration with the on-site system in the people conveyor system 100, 200, while the digital lockings prevent any changes to the people conveyor system 100, 200. This is especially useful when applying critical integration, such as access control system integration.

FIG. 8 illustrates schematically an example of components of the control system 304 of the software maintenance task management system 120. The control system 304 may comprise a processing unit 810 comprising one or more processors, a memory unit 820 comprising one or more memories, a communication unit 830 comprising one or more communication devices, and possibly a user interface (UI) unit 840. The mentioned elements may be communicatively coupled to each other with e.g. a communication bus. The memory unit 820 may store and maintain portions of a computer program (code) 825, and data, e.g. the predefined sequence of software maintenance tasks, the pending software maintenance tasks, the execution status and logging data, or any other data. The computer program 825 may comprise instructions which, when the computer program 825 is executed by the processing unit 810 of the control system 304 may cause the processing unit 810, and thus the control system 304 to carry out desired tasks, e.g. one or more of the method steps described above. The processing unit 810 may thus be arranged to access the memory unit 820 and retrieve and store any information therefrom and thereto. For sake of clarity, the processor herein refers to any unit suitable for processing information and control the operation of the control system 304, among other tasks. The operations may also be implemented with a microcontroller solution with embedded software. Similarly, the memory unit 820 is not limited to a certain type of memory only, but any memory type suitable for storing the described pieces of information may be applied in the context of the present invention. The communication unit 830 provides one or more communication interfaces for communication with any other unit, e.g. the user device 302, the at least one other user device 602a-602d, the people conveyor control system 108, 204, one or more databases, and/or with any other unit. The user interface unit 840 may comprise one or more input/output (I/O) devices, such as buttons, keyboard, touch screen, microphone, loudspeaker, display and so on, for receiving user input and outputting information. The computer program 825 may be a computer program product that may be comprised in a tangible nonvolatile (non-transitory) computer-readable medium bearing the computer program code 825 embodied therein for use with a computer, i.e. the control system 304.

The specific examples provided in the description given above should not be construed as limiting the applicability and/or the interpretation of the appended claims. Lists and groups of examples provided in the description given above are not exhaustive unless otherwise explicitly stated.

1. A method for managing software maintenance tasks of a people conveyor system, the method comprises:
obtaining a predefined sequence of software maintenance tasks of the people conveyor system;
activating digital lockings related to the predefined sequence of software maintenance tasks, wherein the digital lockings prevent execution of software maintenance tasks relating to the people conveyor system initiated by unauthenticated user;
receiving a software maintenance task execution command from a user device, wherein the software maintenance task execution command is generated by the user device in response to an interaction with an authenticated user through the user device; and
initiating execution of the predefined sequence of software maintenance tasks in response receiving the software maintenance task execution command.

2. The method according to claim 1, further comprises storing, after execution of each software maintenance task of the predefined sequence of software maintenance tasks, execution status and logging data related to the execution of said software maintenance task.

3. The method according to claim 1, wherein the software maintenance tasks are arranged into the predefined sequence based on priorities assigned to the software maintenance tasks.

4. The method according claim 1, wherein one or more software maintenance tasks of the predefined sequence of software maintenance task comprise at least one sub-task.

5. The method according to claim 1, further comprising:
receiving an interruption command before executing all software maintenance tasks of the predefined sequence of software maintenance task, wherein the non-executed software maintenance tasks of the predefined sequence of software maintenance tasks are set as pending software maintenance tasks;
interrupting the execution of the pending software maintenance tasks; and
preventing execution of new software maintenance tasks of the people conveyor system before the pending software maintenance tasks are executed.

6. The method according to claim 6, further comprising:
receiving an execution continuation command to continue executing the pending software maintenance tasks from a user device, wherein the execution continuation command is generated by the user device in response to an interaction with an authenticated user through the user device; and
continuing the execution of the pending software maintenance tasks in response receiving the execution continuation command.

7. The method according to claim 1, wherein the plurality of software maintenance tasks of the people conveyor system comprises: one or more software update tasks, one or more software sub-assembly addition tasks, one or more parameter modifying tasks, one or more setting modifying tasks, one or more feature implementation tasks, one or more service implementation tasks, and/or one or more service integration tasks.

8. A software maintenance task management system of a people conveyor system, the software maintenance task management system comprises:
a user device, and
a control system configured to:
obtain a predefined sequence of software maintenance tasks of the people conveyor system;
activate digital lockings related to the predefined sequence of software maintenance tasks, wherein the digital lockings prevent execution of software maintenance tasks relating to the people conveyor system initiated by unauthenticated user;
receive a software maintenance task execution command from the user device, wherein the software maintenance task execution command is generated by the user device in response to an interaction with an authenticated user through the user device; and
initiate execution of the predefined sequence of software maintenance tasks in response receiving the software maintenance task execution command.

9. The software maintenance task management system according to claim 8, wherein the control system is further configured to store, after execution of each software maintenance task of the predefined sequence of software maintenance tasks, execution status and logging data related to the execution of said software maintenance task.

10. The software maintenance task management system according to claim 8, wherein the software maintenance tasks are arranged into the predefined sequence based on priorities assigned to the software maintenance tasks.

11. The software maintenance task management system according to claim 8, wherein one or more software maintenance tasks of the predefined sequence of software maintenance task comprise at least one sub-task.

12. The software maintenance task management system according to claim 8, wherein the control system is further configured to:
receive an interruption command before executing all software maintenance tasks of the predefined sequence of software maintenance task, wherein the non-executed software maintenance tasks of the predefined sequence of software maintenance tasks are set as pending software maintenance tasks;
interrupt the execution of the pending software maintenance tasks; and
prevent execution of new software maintenance tasks of the people conveyor system before the pending software maintenance tasks are executed.

13. The software maintenance task management system according to claim 12, wherein the control system is further configured to:
receive an execution continuation command to continue executing the pending software maintenance tasks from a user device, wherein the execution continuation command is generated by the user device in response to an interaction with an authenticated user through the user device; and
continue the execution of the pending software maintenance tasks in response receiving the execution continuation command.

14. The software maintenance task management system according to claim 8, wherein the plurality of software maintenance tasks of the people conveyor system comprises: one or more software update tasks, one or more software sub-assembly addition tasks, one or more parameter modifying tasks, one or more setting modifying tasks, one or more feature implementation tasks, one or more service implementation tasks, and/or one or more service integration tasks.

15. The method according to claim 2, wherein the software maintenance tasks are arranged into the predefined sequence based on priorities assigned to the software maintenance tasks.

16. The method according to claim 2, wherein one or more software maintenance tasks of the predefined sequence of software maintenance task comprise at least one sub-task.

17. The method according to claim 3, wherein one or more software maintenance tasks of the predefined sequence of software maintenance task comprise at least one sub-task.

18. The method according to claim 2, further comprising:
receiving an interruption command before executing all software maintenance tasks of the predefined sequence of software maintenance task, wherein the non-executed software maintenance tasks of the predefined sequence of software maintenance tasks are set as pending software maintenance tasks;
interrupting the execution of the pending software maintenance tasks; and
preventing execution of new software maintenance tasks of the people conveyor system before the pending software maintenance tasks are executed.

19. The method according to claim 3, further comprising:
receiving an interruption command before executing all software maintenance tasks of the predefined sequence of software maintenance task, wherein the non-executed software maintenance tasks of the predefined sequence of software maintenance tasks are set as pending software maintenance tasks;
interrupting the execution of the pending software maintenance tasks; and
preventing execution of new software maintenance tasks of the people conveyor system before the pending software maintenance tasks are executed.

20. The method according to claim 4, further comprising:
receiving an interruption command before executing all software maintenance tasks of the predefined sequence of software maintenance task, wherein the non-executed software maintenance tasks of the predefined sequence of software maintenance tasks are set as pending software maintenance tasks;
interrupting the execution of the pending software maintenance tasks; and
preventing execution of new software maintenance tasks of the people conveyor system before the pending software maintenance tasks are executed.
